(19) United States
(12) Patent Application Publication
(10) Pub. No.: US 2026/0358818 A1
(43) Pub. Date: Nov. 12, 2026

(54) DYNAMIC ENFORCEMENT OF DO NOT DISTURB MODE IN A VIRTUAL OFFICE

(71) Applicant: INTERNATIONAL BUSINESS MACHINES CORPORATION, ARMONK, NY (US)

(72) Inventors: Sarbajit Kumar Rakshit, Kolkata (IN); Sudheesh S. Kairali, Kozhikode (IN); Binoy Thomas, Kozhikode (IN)

(21) Appl. No.: 19/203,449

(22) Filed: May 9, 2025

(51) Int. Cl. G05D 1/622; G05D 1/65; G05D 105/30; G05D 107/60; G06F 3/01

(52) U.S. Cl. CPC G05D 1/637; G05D 1/65; G06F 3/011; G05D 2105/34; G05D 2107/63

(57) ABSTRACT

An embodiment for dynamically enforcing do not disturb mode in a virtual office is provided. The embodiment may include receiving real-time and historical data relating to an activity in a first location and a remote activity in a second location. The embodiment may also include identifying a context of the remote activity. The embodiment may further include computing a buffer zone around a first user in the first location controlling one or more remote devices in the second location via an augmented reality (AR) device. The embodiment may also include establishing a do not disturb action for the first user within the buffer zone. The embodiment may further include based on determining at least one device in the first location is on a trajectory to enter the buffer zone, causing the at least one device to adapt one or more operational parameters according to the do not disturb action.

### BACKGROUND

The present invention relates generally to the field of computing, and more particularly to a system for dynamically enforcing do not disturb mode in a virtual office.

Teleoperation mode in industrial applications refers to the operation of machines and/or robotic systems from a remote location using telecommunication technologies. Teleoperation allows human operators to control and manipulate these machines and/or robotic systems remotely without being physically present at the location where the operations are taking place. The human operator may use various interfaces, such as joysticks, control panels, and/or extended reality systems to send commands to and receive feedback from the machines and/or robotic systems.

### SUMMARY

According to one embodiment, a method, computer system, and computer program product for dynamically enforcing do not disturb mode in a virtual office is provided. The method, computer system, and computer program product may include receiving real-time and historical data relating to an activity in a first location and a remote activity in a second location. The method, computer system, and computer program product may also include identifying a context of the remote activity based on the historical data. The method, computer system, and computer program product may further include computing a buffer zone around a first user in the first location controlling one or more remote devices in the second location via an augmented reality (AR) device based on the context. The method, computer system, and computer program product may also include establishing a do not disturb action for the first user within the buffer zone based on a type of the remote activity. The method, computer system, and computer program product may further include based on determining at least one device of one or more devices in the first location is on a trajectory to enter the buffer zone, causing the at least one device to adapt one or more operational parameters in accordance with the do not disturb action.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for dynamically enforcing do not disturb mode in a virtual office in a dynamic do not disturb enforcement process according to at least one embodiment.

FIG. 3 is an exemplary diagram depicting a first user in a first location controlling a remote device in a second location according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for dynamically enforcing do not disturb mode in a virtual office. The following described exemplary embodiments provide a system, method, and program product to, among other things, compute a buffer zone around a first user in a first location controlling one or more remote devices in a second location via an extended reality (XR) device based on a context of a remote activity and, accordingly, cause at least one device of one or more devices in a first location to adapt one or more operational parameters in accordance with a do not disturb action. Therefore, the present embodiment has the capacity to improve industrial technology by dynamically configuring devices in the first location to avoid interfering with a user in a virtual office performing a remote activity.

As previously described, teleoperation mode in industrial applications refers to the operation of machines and/or robotic systems from a remote location using telecommunication technologies. Teleoperation allows human operators to control and manipulate these machines and/or robotic systems remotely without being physically present at the location where the operations are taking place. The human operator may use various interfaces, such as joysticks, control panels, and/or extended reality systems to send commands to and receive feedback from the machines and/or robotic systems. When a first user in a first location is controlling one or more remote devices in a second location, one or more devices or another user moving around in the first location may interfere with movements of the first user in a virtual office. This problem is typically addressed by alerting the first user to physical obstacles in the virtual office. However, simply alerting the first user distracts the first user and prevents the continuous progression of the remote activity.

It may therefore be imperative to have a system in place to prevent the first user from being interfered with in the virtual office. Thus, embodiments of the present invention may provide advantages including, but not limited to, preventing the first user from being interfered with in a virtual office, dynamically configuring devices in the first location to avoid interfering with the first user in the virtual office, and assigning an optimum space allocation for both remote activities and non-remote activities. The present invention does not require that all advantages need to be incorporated into every embodiment of the invention.

According to at least one embodiment, when controlling devices in a remote location, real-time and historical data relating to an activity in a first location and a remote activity in a second location may be received in order to identify a context of the remote activity based on the historical data. Upon identifying a context of the remote activity, a buffer zone may be computed around a first user in the first location controlling one or more remote devices in the second location via an augmented reality (AR) device based on the context so that a do not disturb action may be established for the first user within the buffer zone based on a type of the remote activity. Then, based on determining at least one device of one or more devices in the first location is on a trajectory to enter the buffer zone, the at least one device may be caused to adapt one or more operational parameters in accordance with the do not disturb action.

According to at least one embodiment, the adapted operational parameter may include a modified trajectory of the at least one device. In this embodiment, one or more robotic devices in the in the first location may be caused to move one or more physical barriers to an outer boundary of the buffer zone. According to at least one other embodiment, the adapted operational parameter may include a modified speed of the at least one device. According to at least one further embodiment, the adapted operational parameter may include a modified noise level of the at least one device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to compute a buffer zone around a first user in a first location controlling one or more remote devices in a second location via an XR device based on a context of a remote activity and, accordingly, cause at least one device of one or more devices in a first location to adapt one or more operational parameters in accordance with a do not disturb action.

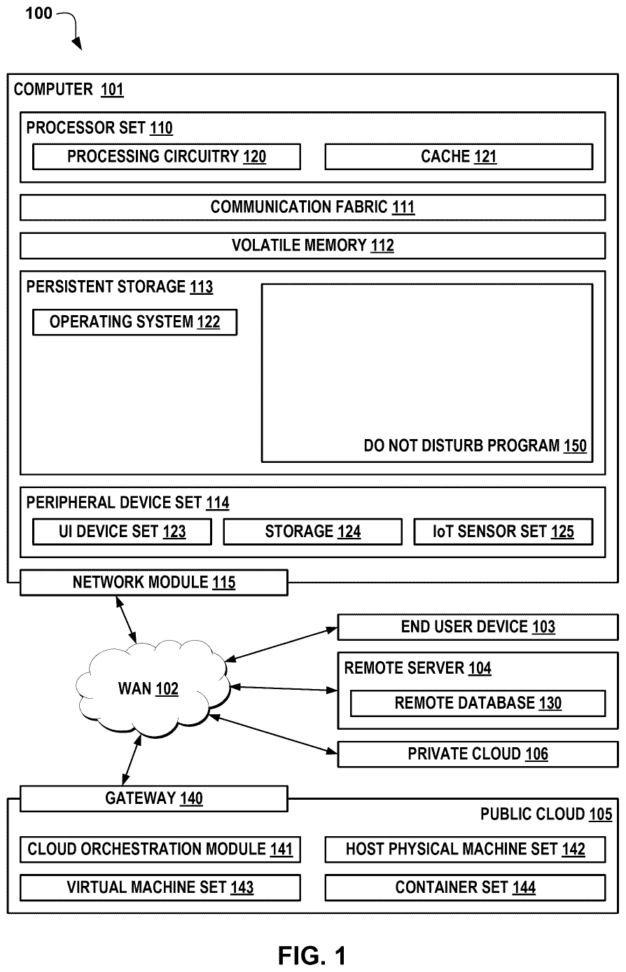

Referring to FIG. 1, an exemplary computing environment 100 is depicted, according to at least one embodiment. Computing environment 100 contains an example of an environment for the execution of at least some of the computer code involved in performing the inventive methods, such as a do not disturb program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include an augmented reality (AR) headset, machines, and/or robotic devices.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

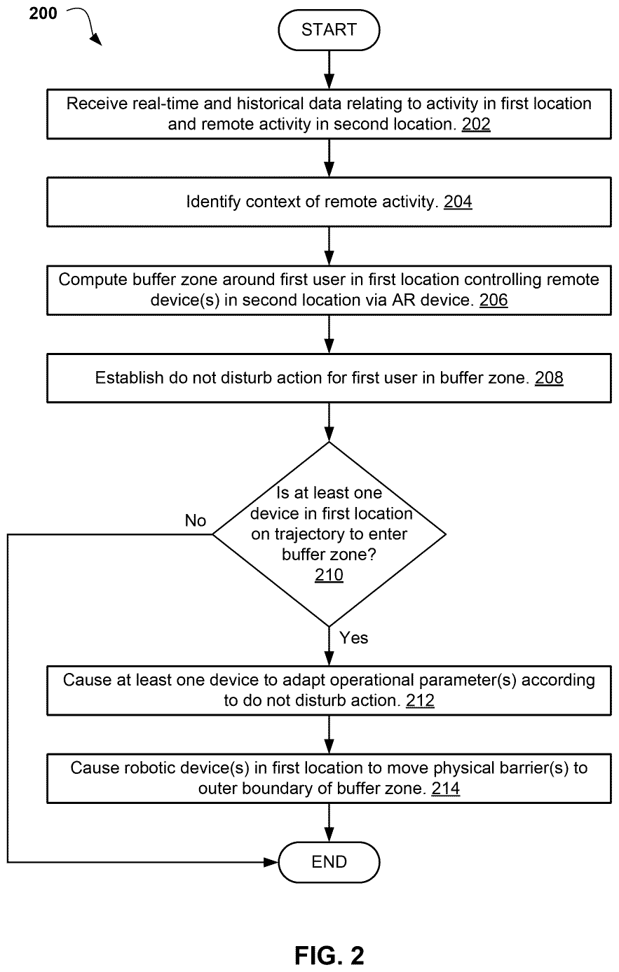

According to the present embodiment, the do not disturb program 150 may be a program capable of receiving real-time and historical data relating to an activity in a first location and a remote activity in a second location, computing a buffer zone around a first user in the first location controlling one or more remote devices in the second location via an XR device based on a context of the remote activity, and causing at least one device of one or more devices in the first location to adapt one or more operational parameters in accordance with a do not disturb action. Furthermore, notwithstanding depiction in computer 101, the do not disturb program 150 may be stored in and/or executed by, individually or in any combination, end user device 103, remote server 104, public cloud 105, and private cloud 106. The do not disturb method is explained in further detail below with respect to FIG. 2. It may be appreciated that the examples described below are not intended to be limiting, and that in embodiments of the present invention the parameters used in the examples may be different.

Referring now to FIG. 2, an operational flowchart for dynamically enforcing do not disturb mode in a virtual office in a dynamic do not disturb enforcement process 200 is depicted according to at least one embodiment. At 202, the do not disturb program 150 receives the real-time and the historical data relating to the activity in the first location and the remote activity in the second location. The first location and the second location may be any location where industrial activities are performed, so long as the first location is different from the second location.

In embodiments of the present invention, the first location is where the first user is located and the second location is remote from the first user. For example, the second location may be hundreds or thousands of miles away from the location of the first user. The real-time data may include, but is not limited to, types of activities being performed in the first location and the second location, a mobility path of the one or more devices in the first location, and/or a mobility path of the one or more remote devices in the second location. For example, the activity in the first location may be manufacturing objects at different stations on an industrial floor and the remote activity in the second location may be moving objects from one location to another (e.g., from a container ship onto a pier).

The historical data may include, but is not limited to, a complexity of the remote activity, a latency of the one or more remote devices in accepting a command of the first user, limitations of an AR or virtual reality (VR) device, and/or types of controls of the one or more remote devices. For example, the types of controls of the one or more remote devices may include, but are not limited to, a joystick, a control panel, and/or hand gestures made by the first user.

Then, at 204, the do not disturb program 150 identifies the context of the remote activity. The context is identified based on the historical data. The context of the remote activity may include, but is not limited to, the types of remote devices used to perform the remote activity, weather conditions at the second location, and/or operations associated with the remote activity. For example, where the remote activity involves moving objects from one location to another, the operations may include a crane picking up containers from a ship and placing them on a dock for unloading.

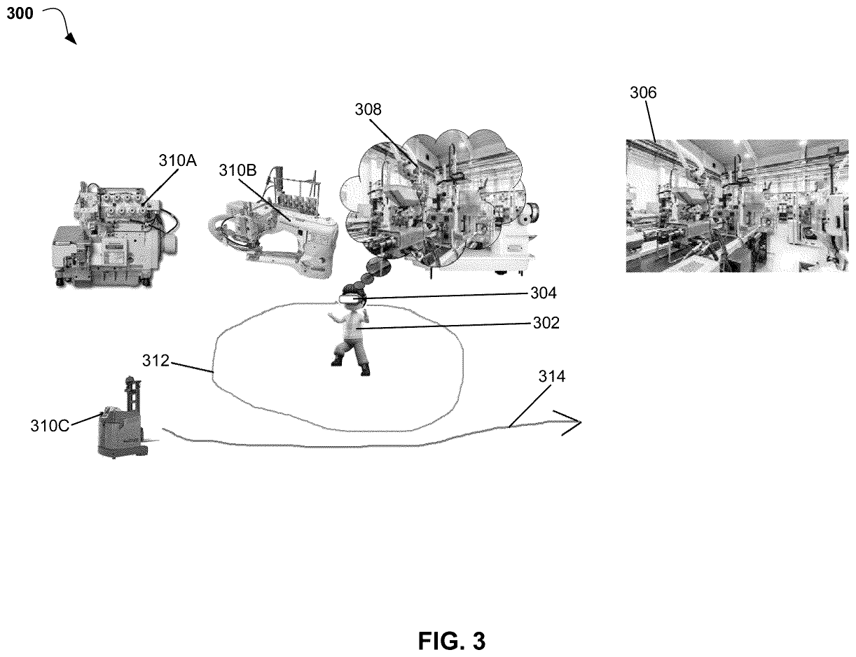

Next, at 206, the do not disturb program 150 computes the buffer zone around the first user in the first location controlling the one or more remote devices in the second location via the AR device. The buffer zone may be computed based on the context. The first user may be physically present in the first location and wearing an AR device to control the one or more remote devices in the second location. For example, the user may be controlling the one or more remote devices from a floor of an industrial manufacturing facility. As used herein, “buffer zone” means an enclosed area within the first location where the first user is able to control the one or more remote devices via the AR device. The buffer zone may extend radially outwardly from the user and may be defined by an outer boundary, as illustrated in FIG. 3. In this manner, the buffer zone may be a virtual office for the first user where the first user can perform a range of motions without interference from any external object. Thus, the first user may perform virtual mobility while controlling the one or more remote devices in the second location, while at the same time performing movements in the first location. For example, the first user may clutch their fist in the first location, and that clutching of the fist may virtually cause the one or more remote devices to grasp and object.

The historical data may include a mapping of specific buffer zones to accidental situations for the remote activity. For example, where the remote activity includes moving objects from one location to another, a buffer zone with a radius of 5 feet resulted in an object being dropped in the remote activity due to a collision between the first user and at least one device in the first location, whereas a buffer zone with a radius of 10 feet resulted in the activity being successfully completed. The buffer zones that resulted in the activity being successfully completed may be stored in a knowledge corpus, such as remote database 130.

According to at least one embodiment, a size of the buffer zone around the first user is computed based on the range of motions performed by the first user when controlling the one or more remote devices in the second location. The range of motions may include, but are not limited to, an extension of the arms of the first user from the side or front of the body, walking around in the first location, and/or hand movements to interact with controllers of the one or more remote devices. The size of the buffer zone may be directly proportional to the range of motions.

For example, where the first user has to walk 10 feet to grab additional tools, the radius of the buffer zone may be 12 feet. Where the user has to walk 5 feet to grab additional tools, the radius of the buffer zone may be 7 feet. Where the controller for a remote device is a joystick and the controller for another remote device is the control panel, the size of the buffer zone when the first user uses the control panel may be larger than the size of the buffer zone when the first user uses the joystick, since the control panel may require more side-to-side movements of the first user.

According to at least one other embodiment, a size of the buffer zone around the first user is directly proportional to a latency of the one or more remote devices in accepting a command of the first user. A greater latency results in a greater buffer zone size. For example, where the latency for a remote device is 5 seconds and the latency for a different remote device is 10 seconds, the buffer zone where the first user is controlling the remote device having the latency of 10 seconds may be larger than the buffer zone where the first user is controlling the remote device having the latency of 5 seconds.

According to at least one further embodiment, a size of the buffer zone around the first user is inversely proportional to a tracking range of the AR device. For example, where the tracking range of a first AR device is 5 feet and the tracking range of a second AR device is 10 feet, the buffer zone where the first user has the first AR device with the tracking range of 5 feet may be larger than the buffer zone where the first user has the second AR device with the tracking range of 10 feet.

Then, at 208, the do not disturb program 150 establishes the do not disturb action for the first user within the buffer zone. The do not disturb action is established based on the type of the remote activity. In the context of VR/AR, a do not disturb action may refer to rules or guidelines that are established to ensure uninterrupted and focused VR/AR experiences. Different types of remote activities may have various levels of criticality and danger. For example, the remote activity may be classified as safe, intermediate, or dangerous.

According to at least one embodiment, the do not disturb action may include a rule to avoid entrance into the buffer zone altogether. For example, where the remote activity is classified as dangerous and an inadvertent movement of the first user, due to being distracted or collided with by at least one device in the first location, may result in harm to people or property, the do not disturb action may be to avoid entering the buffer zone.

According to at least one other embodiment, the do not disturb action may include a rule to reduce anything that may distract the first user. For example, where the remote activity is classified as intermediate or safe, the do not disturb action may be to lower the risk of distracting the first user, while not prohibiting entrance into the buffer zone altogether.

Next, at 210, the do not disturb program 150 determines whether the at least one device of the one or more devices in the first location is on a trajectory to enter the buffer zone. One or more cameras and/or other sensors embedded in the AR device may capture movements of the one or more devices and any other second users in the first location. For example, when the one or more cameras and/or other sensors detect a fork lift moving toward the first user, the do not disturb program 150 may make the determination that the at least one device is on the trajectory to enter the buffer zone.

According to at least one embodiment, determining whether the at least one device of the one or more devices in the first location is on the trajectory to enter the buffer zone may include determining whether the second user is on the trajectory to enter the buffer zone. Similar to how the one or more cameras and/or other sensors embedded in the AR device capture movements of the one or more devices in the first location, the one or more cameras and/or other sensors may capture the movements of the second user in the first location. The second user may not be controlling the one or more remote devices in the second location from the first location, but may nevertheless be wearing an AR device. Accordingly, based on determining the second user is on the trajectory to enter the buffer zone, an AR visualization of the buffer zone surrounding the first user may be displayed to the second user via a different AR device. For example, the second user may see an AR visualization of the buffer zone depicted in FIG. 3. In this manner, the second user may, in response to the AR visualization, avoid entering the buffer zone.

Based on determining the at least one device is on the trajectory to enter the buffer zone (step 210, “Yes” branch), the dynamic do not disturb enforcement process 200 proceeds to step 212 to cause the at least one device to adapt the one or more operational parameters in accordance with the do not disturb action. Based on determining the at least one device is not on the trajectory to enter the buffer zone (step 210, “No” branch), dynamic do not disturb enforcement process 200 ends.

Then, at 212, the do not disturb program 150 causes the at least one device to adapt the one or more operational parameters in accordance with the do not disturb action. The do not disturb program 150 may send a signal to the at least one device, which may increase or reduce the energy used by the at least one device to adapt the one or more operational parameters.

According to at least one embodiment, where the do not disturb action includes a rule to avoid entrance into the buffer zone altogether, causing the at least one device to adapt the one or more operational parameters in accordance with the do not disturb action may include causing the at least one device to change the trajectory such that the at least one device avoids entering the buffer zone. In this embodiment, the at least one device may be outside the outer boundary of the buffer zone. For example, the forklift may adapt its trajectory to bypass the outer boundary of the buffer zone, as illustrated in FIG. 3.

According to at least one other embodiment, where the do not disturb action includes a rule to reduce anything that may distract the first user, causing the at least one device to adapt the one or more operational parameters in accordance with the do not disturb action may include causing the at least one device to reduce a speed of the at least one device upon an entry into the buffer zone and to resume the speed upon an exit of the buffer zone. For example, the forklift may initially be travelling at a speed of 5 miles per hour (MPH). Continuing the example, when the forklift enters the buffer zone, the speed may be reduced to 2 MPH, and then back to 5 MPH once the forklift exits the buffer zone. In addition to changing the speed of the at least one device, other operational parameters may be adapted to reduce distractions to the first user. Examples include reducing revolutions per minute (RPMs) of a motor of the at least one device, reducing a noise level of the at least one device, reducing the heat generated by the at least one device, and/or reducing the odor released by the at least one device (e.g., cease outputting exhaust fumes while travelling through the buffer zone.

Next, at 214, the do not disturb program 150 causes the one or more robotic devices in the first location to move the one or more physical barriers to the outer boundary of the buffer zone. The one or more robotic devices may move the one or more physical barriers to the outer boundary of the buffer zone based on determining the at least one device is on the trajectory. The do not disturb program 150 may send a signal to the one or more robotic devices which may activate a drive belt or other movement mechanism of the one or more robotic devices to move the one or more physical barriers to the outer boundary of the buffer zone. The one or more robotic devices may be a part of the one or more devices in the first location that are used to perform the activity in the first location. Alternatively, the one or more robotic devices may exist in the first location solely to move the physical barriers to protect the first user from interference. The one or more physical barriers may include, but are not limited to, a movable fence, a movable gate, and/or construction cones. For example, the one or more robotic devices may move the one or more physical barriers to form a circular enclosure that protects the first user.

Referring now to FIG. 3, an exemplary diagram 300 depicting a first user 302 in a first location controlling a remote device in a second location 306 is shown according to at least one embodiment. In the diagram 300, the first user 302 may be wearing the AR device 304 to control the one or more remote devices in the second location 306. In FIG. 3, the second location 306 is the real-world version of the second location 306, whereas the VR second location 308 is a VR depiction of the real-world version of the second location 306. It may be appreciated that the VR second location 308 may be what the first user 302 is visualizing through the AR device 304. The do not disturb program 150 may create a mapping between objects in the physical world and objects in the virtual world. Thus, the VR second location 308 may include a virtual representation of the one or more remote devices in the second location 306, and a virtual representation of the movements of the first user 302 that align with the movements of the first user 302 in the real-world. As the first user 302 is controlling the one or more remote devices in the second location 306, a plurality of devices 310A, 310B, 310C in the first location may be performing a different activity. The buffer zone 312 may be created such that the first user 302 can perform the remote activity without interruption or distraction. The buffer zone 312 may form a circular enclosure that protects the first user 302.

Based on determining the plurality of devices 310A, 310B, 310C are on the trajectory to enter the buffer zone 312, the one or more operational parameters of the plurality of devices 310A, 310B, 310C may be adapted. For example, a first device 310A and a second device 310B may reduce their speed and/or noise when entering the buffer zone 312. Additionally, the third device 310C may change the trajectory such that the third device 310C avoids entering the buffer zone 312. Arrow 314 illustrates a modified movement path of the third device 310C to bypass the buffer zone 312.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of dynamically enforcing do not disturb mode in a virtual office, the method comprising:
receiving real-time and historical data relating to an activity in a first location and a remote activity in a second location;
identifying a context of the remote activity based on the historical data;
computing a buffer zone around a first user in the first location controlling one or more remote devices in the second location via an augmented reality (AR) device based on the context;
establishing a do not disturb action for the first user within the buffer zone based on a type of the remote activity;
determining whether at least one device of one or more devices in the first location is on a trajectory to enter the buffer zone; and
based on determining the at least one device is on the trajectory, causing the at least one device to adapt one or more operational parameters in accordance with the do not disturb action.

2. The computer-based method of claim 1, further comprising:
based on determining the at least one device is on the trajectory, causing one or more robotic devices in the first location to move one or more physical barriers to an outer boundary of the buffer zone.

3. The computer-based method of claim 1, wherein determining whether the at least one device of the one or more devices in the first location is on the trajectory to enter the buffer zone further comprises:
determining whether a second user is on the trajectory to enter the buffer zone; and
based on determining the second user is on the trajectory, displaying an AR visualization of the buffer zone to the second user via a different AR device.

4. The computer-based method of claim 1, wherein causing the at least one device to adapt the one or more operational parameters in accordance with the do not disturb action further comprises:
causing the at least one device to change the trajectory such that the at least one device avoids entering the buffer zone.

5. The computer-based method of claim 1, wherein causing the at least one device to adapt the one or more operational parameters in accordance with the do not disturb action further comprises:
causing the at least one device to reduce a speed of the at least one device upon an entry into the buffer zone and to resume the speed upon an exit of the buffer zone.

6. The computer-based method of claim 1, wherein a size of the buffer zone around the first user is computed based on a range of motions performed by the first user when controlling the one or more remote devices in the second location.

7. The computer-based method of claim 1, wherein a size of the buffer zone around the first user is directly proportional to a latency of the one or more remote devices in accepting a command of the first user, wherein a greater latency results in a greater buffer zone size.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data relating to an activity in a first location and a remote activity in a second location;
identifying a context of the remote activity based on the historical data;
computing a buffer zone around a first user in the first location controlling one or more remote devices in the second location via an augmented reality (AR) device based on the context;
establishing a do not disturb action for the first user within the buffer zone based on a type of the remote activity;
determining whether at least one device of one or more devices in the first location is on a trajectory to enter the buffer zone; and
based on determining the at least one device is on the trajectory, causing the at least one device to adapt one or more operational parameters in accordance with the do not disturb action.

9. The computer system of claim 8, the method further comprising:
based on determining the at least one device is on the trajectory, causing one or more robotic devices in the first location to move one or more physical barriers to an outer boundary of the buffer zone.

10. The computer system of claim 8, wherein determining whether the at least one device of the one or more devices in the first location is on the trajectory to enter the buffer zone further comprises:
determining whether a second user is on the trajectory to enter the buffer zone; and
based on determining the second user is on the trajectory, displaying an AR visualization of the buffer zone to the second user via a different AR device.

11. The computer system of claim 8, wherein causing the at least one device to adapt the one or more operational parameters in accordance with the do not disturb action further comprises:
causing the at least one device to change the trajectory such that the at least one device avoids entering the buffer zone.

12. The computer system of claim 8, wherein causing the at least one device to adapt the one or more operational parameters in accordance with the do not disturb action further comprises:
causing the at least one device to reduce a speed of the at least one device upon an entry into the buffer zone and to resume the speed upon an exit of the buffer zone.

13. The computer system of claim 8, wherein a size of the buffer zone around the first user is computed based on a range of motions performed by the first user when controlling the one or more remote devices in the second location.

14. The computer system of claim 8, wherein a size of the buffer zone around the first user is directly proportional to a latency of the one or more remote devices in accepting a command of the first user, wherein a greater latency results in a greater buffer zone size.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data relating to an activity in a first location and a remote activity in a second location;
identifying a context of the remote activity based on the historical data;
computing a buffer zone around a first user in the first location controlling one or more remote devices in the second location via an augmented reality (AR) device based on the context;
establishing a do not disturb action for the first user within the buffer zone based on a type of the remote activity;
determining whether at least one device of one or more devices in the first location is on a trajectory to enter the buffer zone; and
based on determining the at least one device is on the trajectory, causing the at least one device to adapt one or more operational parameters in accordance with the do not disturb action.

16. The computer program product of claim 15, the method further comprising:
based on determining the at least one device is on the trajectory, causing one or more robotic devices in the first location to move one or more physical barriers to an outer boundary of the buffer zone.

17. The computer program product of claim 15, wherein determining whether the at least one device of the one or more devices in the first location is on the trajectory to enter the buffer zone further comprises:
determining whether a second user is on the trajectory to enter the buffer zone; and
based on determining the second user is on the trajectory, displaying an AR visualization of the buffer zone to the second user via a different AR device.

18. The computer program product of claim 15, wherein causing the at least one device to adapt the one or more operational parameters in accordance with the do not disturb action further comprises:
causing the at least one device to change the trajectory such that the at least one device avoids entering the buffer zone.

19. The computer program product of claim 15, wherein causing the at least one device to adapt the one or more operational parameters in accordance with the do not disturb action further comprises:
causing the at least one device to reduce a speed of the at least one device upon an entry into the buffer zone and to resume the speed upon an exit of the buffer zone.

20. The computer program product of claim 15, wherein a size of the buffer zone around the first user is computed based on a range of motions performed by the first user when controlling the one or more remote devices in the second location.
